(19) United States
(12) Patent Application Publication
(10) Pub. No.: US 2008/0308968 A1
(43) Pub. Date: Dec. 18, 2008

(54) Method of making a low-dust building panel

(76) Inventor: Salvatore C. Immordino, JR., Trevor, WI (US)

Correspondence Address: GREER, BURNS & CRAIN, LTD., 300 SOUTH WACKER DRIVE, SUITE 2500, CHICAGO, IL, 60603, US

(21) Appl. No.: 11/818,186

(22) Filed: Jun. 13, 2007

(51) Int. Cl. B27N 3/04; B29C 39/00

(52) U.S. Cl. 264/257; 264/239; 264/299

(57) ABSTRACT

A dust-reducing building panel is made by selecting a dedusting agent that is a solid at room temperature but that melts to form composite particles by at least one of agglomerating and surface adsorption of fines under conditions selected from the group consisting of cutting, abrading or sanding. The dedusting agent is used to make a slurry including water and a hydraulic material selected from the group consisting of calcium sulfate hemihydrate and cement. After the slurry is made, it is deposited onto a facing material and formed into a panel. The building panel is then allowed to set. Some embodiments of the building utilize a dedusting agent that includes natural or synthetic waxes.

### BACKGROUND OF THE INVENTION

This invention relates to a method of making a building panel that produces less dust when cut, sanded or abraded. More specifically, it relates to building panels containing a dedusting agent that agglomerates dust fines as they are generated.

Building panels are used in the construction trades to construct walls, floors and ceilings, generally for indoor use. Hydraulic materials, including gypsum and cement, are combined with water, formed into a shape, then allowed to set. Panels are made with a wide variety of properties for use in many specific locations. Panels made primarily of cement are used as floor underlayment, for example, with ceramic floor tile. Conventional gypsum panels are used to make walls and ceilings for interior use. Specialty panels, of either cement or gypsum, are used in areas where particular properties are needed. Cement board, such as DUROCK Cement Panels made by United States Gypsum Company (Chicago, Ill.) is useful as a support for a shower base or ceramic tiles in a bathroom. The cement board is not subject to mold growth and is not damaged by water should a leak develop. Gypsum board is also available for use in bathrooms where an asthetically pleasing surface is desired. Building panels such as HUMITEK or MOLD TOUGH Gypsum Panels by United States Gypsum (Chicago, Ill.) are water resistant and/or mold resistant for use in damp or humid environments.

These building panels are particularly preferred for construction because they are easily cut to any desired height and length using readily available cutting tools, such as a circular saw, a wet saw, a mat knife and the like. The cut edges can also be sanded where needed to eliminate sharp edges or to remove small amounts of gypsum for a tight fit. However, when the panel is cut or sanded, large amounts of dust are generated as the dihydrate crystals are abraded. There is an increasing trend towards the use of high speed machine tools, even for use with gypsum panels. Cut-outs for outlets, switches and the like are made quickly and easily with tools such as a ROTO ZIP® cutting tool. These tools create large amounts of fine dust particles compared to cutting the panels using hand tools.

The particles that become airborne are more problematic. The gypsum particles are very fine and can become entrained in the air, traveling long distances before settling out. Fine dust penetrates closed doors and through air ducts, often leaving gypsum dust throughout the house or building where the construction takes place. While airborne, the dust particles also have the potential to be inhaled by those living or working in the space. Gypsum products that produce less dust when cut or abraded have long been sought by those skilled in the art. Reduced dusting would significantly reduce the time needed to clean up the fine gypsum powder that is widely dispersed.

The addition of dedusting agents to joint compounds is described in U.S. Pat. No. 6,673,144. A sprayable plaster that utilizes polyethylene glycol as an internal binder produces less fine dust when machined in U.S. Pat. No. 6,355,099. None of these references disclose the addition of a dedusting agent to the manufacture of gypsum panels which is a complex, high-speed process. Unexpected chemical interactions can slow or stop the manufacturing process by retarding the setting process or clogging valves with unknown precipitates. Additives must be carefully tested to ensure that they to not interfere with the hydration reactions or the action of other additives.

### SUMMARY OF THE INVENTION

These and other problems are addressed by the present invention to an improved building panel that reduces the amount of airborne dust that is released when the building panel is sanded, cut or abraded.

A dust-reducing building panel is made by selecting a dedusting agent that is a solid at room temperature but that melts to form composite particles by at least one of agglomerating and surface adsorption of fines under conditions selected from the group consisting of cutting, abrading or sanding. The dedusting agent is used to make a slurry including water and a hydraulic material selected from the group consisting of calcium sulfate hemihydrate and cement. After the slurry is made, it is deposited onto a facing material and formed into a panel. The building panel is then allowed to set. Some embodiments of the building utilize a dedusting agent that includes natural or synthetic waxes as dedusting agents.

One embodiment of the building panel is particularly useful because dust fines are agglomerated as they are created resulting in a cleaner workplace. The installer's vision is not impaired by airborne fines. The amount of dust that remains entrained in the air to be carried to different areas of the building is minimized.

Further, the dedusting additives do not interfere with other chemical reactions that take place. No retardation of the hydration reactions is found that would slow the manufacturing line. Unwanted chemical reactions are also minimized, further enhancing production.

### DETAILED DESCRIPTION OF THE INVENTION

The first step in making a dust-reducing building panel is selecting a dedusting agent. The dedusting agent is selected to be a solid at room temperature but melts to agglomerate fines under conditions selected from the group consisting of cutting, abrading or sanding. Under conditions of cutting, sanding or abrading, heat generated by friction warms the building panel in the vicinity of the friction. The dedusting agent in the vicinity is melted by the heat. As fines are generated, they cling to the surface of the droplet of dedusting agent to form a composite particle rather than become dispersed in the air. When the droplet becomes heavy with dust, or is knocked loose by the cutting, abrading or sanding process, it falls away from the heated surface. The droplet solidifies as it falls, holding the dust particles in the solidified dedusting agent.

Melting point is one criterion to be considered when selecting a dedusting agent. Melting point temperatures of at least 80° F. (27° F.) are used to assure that the dedusting agent is solid at room temperature, however, the ambient or room temperature must be considered. If construction is taking place on a hot summer day in the southern United States, a higher melting dedusting agent would be desirable. In such cases, melting points of at least 90° F. (32° C.) or even 100° F. (38° C.) for the dedusting agent are useful. The melting point should also be low enough that the dedusting agent melts under conditions were the fines are generated. Use of high speed tools generates friction, increasing the temperature of the area being machined. In some embodiments, dedusting agents having a melting point of 150° F. (66° C.) are suitable. Melting point ranges of the dedusting agents in some embodiments are from 90° F. (32° C.) to about 150° F. (66° C.). Some embodiments use dedusting agents having a melting point of about 90° F. (32° C.) to about 120° F. (49° C.), or from about 100° F. (38° C.) to about 150° F. (66° C.). Where very high friction is generated, selection of a dedusting agent having a melting point above 150° F. (66° C.) is contemplated.

Dedusting agents are an inert, non-reactive, readily dispersed additive that tends to adsorb to the surface of the fine dust particles while at the same time having an affinity to itself. The preferred dedusting agent is one that is a solid at room temperature, melts under cutting conditions, and then resolidifies to agglomerate and bind the dust fines into the composite particle as the cuttings fall away from the panel.

One or more dedusting agents is added to the gypsum either before or after the slurry water is added. Suitable dedusting agents include paraffin waxes and synthetic waxes, such as polyethylene glycols. Preferably, the dedusting agent is a high molecular weight amorphous polyethylene glycol powder. Polyethylene glycols having melting points just above room temperature are preferably utilized with this invention for a number of reasons. These materials have phase change characteristics which are directly related to their molecular weight. Lower molecular weight polyethylene glycols exist as a liquid at room temperature while higher molecular weights exist as a solid. The solid forms make them suitable for use in the preparation of dry compositions, as well as liquid forms. The lower molecular weight forms can adsorb on the surface of dust fines thereby sticking them together. The higher molecular weight forms can utilize surface adsorption, mechanical agglomeration or both to form the composite particles from the dust fines via phase change from solid to liquid. Molecular weight also impacts the degree of solubility. Higher molecular weight polyethylene glycols have lower solubility than lower molecular weight polyethylene glycols. The lower solubility of the solid forms makes them less susceptible to leaving concentration gradients upon drying as a result of transport by water migration via evaporation. Polyethylene glycol (“PEG”), also referred to under its common name polyethylene oxide or its IUPAC name polyoxy-1-ethylene, is commercially available and also may be prepared by many known and conventional polymerization techniques. In a preferred embodiment, a polyethylene glycol powder having a molecular weight of 2,000 Daltons to about 8,000 Daltons is used to provide good dedusting characteristics for a number of building materials. Use of a non-powder form of polyethylene glycol is also contemplated. However, as the molecular weight decreases, it becomes more difficult to manufacture polyethylene glycol in powder form.

A preferred PEG is in the form of a dry powder that is conveniently added to a dry mixture. The dry mixture includes up to 13 percent, more preferably approximately in the range of 0.1 to 8 percent, and most preferably 0.5 to 6 percent, by weight based on the weight of the hydraulic component. Amorphous polyethylene glycol powder is available under the trade name CARBOWAX® from Dow Chemical Company of Midland, Mich. or Polyglycol from Clariant Corporation of Mount Holly, N.C. In gypsum products, the minimum amount of PEG that provides satisfactory dust control is preferably used. PEG has been shown to increase the drying time of gypsum products, thus requiring additional time in the drying kiln to obtain a specific level of dryness. Slowing of the process occurs only with evaporation of the residual water, not hydration, so the set times are not effected.

A highly branched, water redispersable, free flowing polymer, namely, methoxy polyethylene glycol, could also be used as an internal binder in place of the polyethylene glycol polymer. T-PEGS (tetrahydrofuran polyethylene glycols) are also contemplated or use in these compositions. In the present composition, a preferred molecular weight of the methoxy polyethylene glycol polymer is between 2,000 and 5,000.

In some embodiments, it is desirable to predisperse the dedusting agent in water. Some dedusting agents are difficult to wet and require time to disperse. Optionally, the dedusting is melted prior to addition to the water or the water is warmed to aid in dispersion. Preparation of a predispersed dedusting agent allows more uniform distribution of the dedusting agent, particularly on a high-speed manufacturing line where residence time in the mixer is on the order of seconds.

Alternately, the PEG is formed in situ by adding an alkoxy-substituted alkylene oxide to the gypsum slurry prior to set. The oxide reacts with water in the presence of an acid catalyst. Since there is no control over the polymerization reactions, a wide range of PEG molecular weights is formed. This is beneficial since it is unknown exactly which PEG would be most effective. Harder substrates, such as cement backing boards, would benefit from having harder, higher molecular weight PEG present. Harder substrates require a harder PEG that will soften at a higher temperature. In an embodiment to a concrete panel using PEG, the molecular weight of the PEG is in excess of 20,000 Daltons. Softer substrates will generate fines at lower temperatures and should, therefore, utilize a lower molecular weight PEG for agglomerating these materials.

Natural waxes, such as paraffins, beeswax, palm wax or soy wax, are also useful as dedusting agents as long as they have the melting point characteristics suitable to make the wax a solid at room temperature, but softens or liquefies when friction is applied. Dust generated by the friction, such as during cutting, sanding or abrading, is agglomerated by the wax while it is soft. When the agglomerated wax falls away from the workpiece, it resolidifies with the dust particles, making dust removal considerably simpler. As described with the PEG, higher molecular waxes and/or oils are optionally used with harder cement panels. Preferred natural waxes include C₁₈-C₂₉ paraffins. Waxes are blendable to obtain average melting points that can agglomerate dust fines under a variety of different cutting actions, such as that exhibited with high speed cutting tools or through the use of a hand held safety blade.

Hydraulic materials are minerals that set to a hard product by admixture of water that chemically combines with the minerals to form a hydrate. Stucco is made up of calcium sulfate hemihydrate, which hydrates to calcium sulfate dihydrate in a matter of minutes. SHEETROCK® Brand Gypsum Panels (United States Gypsum Company, Chicago, Ill.) are an example of stucco-based building panels. The silicate compounds of cement take longer to hydrate. This accounts for the longer set time of cement compared to gypsum. An example of a building panel made with cement is DUROCK® Brand Cement Board (United States Gypsum Company, Chicago, Ill.). Pozzolans, including lime and fly ash, are other examples of hydraulic materials. Building panels made from mixtures of hydraulic materials is also contemplated.

In one embodiment of the invention, stucco or calcium sulfate hemihydrate is used to make a gypsum panel. A gypsum panel is made in U.S. Pat. No. 6,893,752, herein incorporated by reference. Two forms of stucco are commonly available. An alpha form is made by calcining landplaster under pressure. It is an acicular form that flows readily. A beta form produces needle-like crystals. This form is less expensive, but requires more water for flowability. Either form, or a mixture of both forms, is used in wallboard panels, but beta-calcined calcium sulfate is more commonly used due to its reasonable price and ready availability. When added to water, the calcium sulfate hemihydrate is converted to the dihydrate form, forming an interconnected matrix of dihydrate crystals. As the water of hydration is adsorbed, the slurry sets and hardens to make the finished product.

Water is present in any amount useful to make a flowable slurry from the hydraulic material. A suitable amount of water exceeds the amount needed to hydrate all of the hydraulic material. The exact amount of water is determined, at least in part, by the hydraulic material selected and the application with which the product will be used, the amount and type of additives used and whether the alpha or beta form of the stucco is used. A preferred ratio is calculated based on the weight of water compared to the weight of the dry hydraulic material. Preferred ratios range from about 0.6:1 to about 1:1.

The core is formed adjacent to the facing material from the slurry of the dedusting agent and the stucco. Addition of the dedusting agent to the slurry allows it to distribute throughout the slurry and the resulting crystal matrix. The suitable dedusting agent is present as a solid in the crystal matrix at room temperature, but liquefies or becomes tacky when friction is applied and locally raises the temperature of a portion of the building panel.

The slurry is formed by mixing the dry components and the wet components together. Dry components of the slurry, the calcined gypsum and any dry additives, are blended together prior to entering the mixer. Water is measured directly into the mixer. Liquid additives are added to the water, and the mixer is activated for a short time to blend them. The dry components are added to the liquid in the mixer, and blended until the dry components are moistened.

A facing material is optionally present on at least one face of the building panel. Whereas a building panel has a plurality of sides or faces, it is not necessary that all faces be covered with a facing material. In some circumstances, one or more sides are optionally left unfaced. One embodiment of this invention is the cement panel having a facing on only one face. Another embodiment is the gypsum panel having at least a second face and a second facing material on the second face. Where more than one face is covered with facing material, the facing material on any one face is optionally the same or different than the facing material used on any other face.

Any known facing material may be used to face the building panel. Facing materials containing paper, pulp or any starch are the most common. Pressed paper is a preferred facing material for gypsum panels due to its common availability and low cost. Facing paper is optionally bleached or unbleached. The paper comprises one or more layers or plies. It is contemplated that, where multiple plies are used, it is suitable for one or more plies to differ from each other in one or more respects. Smooth, bleached papers are frequently provide a good surface on one side of gypsum panels for painting or decorating. The face of the gypsum panel opposing the face to be decorated is placed against a substrate where it is not seen. This face is often covered with an unbleached paper surface.

Where the panel is used for sound absorption, the facing material is optionally an acoustically transparent facing. These materials allow sound to pass therethrough rather than reflect it back to its source. Examples of acoustically transparent facings are woven glass scrims or fiberglass. Sound is transmitted between the fibers of the glass. Paper is generally an acoustically reflective material unless it has been needled, providing holes through which the sound waves can penetrate the paper.

It is also contemplated that facing material other than paper be used in this invention. Facing materials are also made of plastics, fibers, woven or non-woven fabrics. Cement panels are often faced with a plastic scrim for strength. Fiberglass or other fibers are also known as facing materials in panels of this type. When cement panels are created, facing material is generally used on one face. Preferably, the facing is a scrim made of a natural or plastic material that is placed on one face only. However, the use of two or more facings on a concrete panel is contemplated.

The slurry is then mixed to achieve a homogeneous slurry. Usually, an aqueous foam is mixed into the slurry to control the density of the resultant core material. Such an aqueous foam is usually generated by high shear mixing of an appropriate foaming agent, water and air to prior to the introduction of the resultant foam into the slurry. The foam can be inserted into the slurry in the mixer, or preferably, into the slurry as it exits the mixer in a discharge conduit. See, for example, U.S. Pat. No. 5,683,635, herein incorporated by reference. In a gypsum board plant, frequently solids and liquids are continuously added to a mixer, while the resultant slurry is continuously discharged from the mixer, and has an average residence time in the mixer of less than 30 seconds.

The slurry is continuously dispensed through one or more outlets from the mixer through a discharge conduit and deposited onto a moving conveyor carrying the facing material and formed into a panel. Another paper cover sheet is optionally placed on top of the slurry, so that the slurry is sandwiched between two moving cover sheets which become the facings of the resultant gypsum panel. The thickness of the resultant board is controlled by a forming roll, and the edges of the board are formed by appropriate mechanical devices which continuously score, fold and glue the overlapping edges of the paper. Additional guides maintain thickness and width as the setting slurry travels on a moving belt. While the shape is maintained, the calcined gypsum is maintained under conditions sufficient (i.e. temperature of less than about 120° F. (49° C.)) to react with a portion of the water to set and form an interlocking matrix of gypsum crystals. The board panels are then cut, trimmed and passed to a kiln to dry the set, but still somewhat wet, boards.

Another embodiment of the invention relates to cement boards or panels. An example of a cement panel and how to make it is taught in U.S. Pat. No. 5,030,502, herein incorporated by reference. Portland cement is a preferred cement. Other suitable cements are phosphate cements and hydraulic cements.

For cement-based building materials, the dedusting agent is also selected to melt at temperatures generated by the machining, cutting or abrading of the product. As above, the dedusting agent is selected to melt while the dust fines are being generated, agglomerating them so that they settle quickly and are less likely to become airborne.

Dry ingredients are combined with each other. Additives in solid form, such as the dedusting agent and set accelerators, are combined with the cement and aggregate before entering the mixer. After the dry materials are introduced to the mixer, water and other liquids are added to the mixer where they are mixed until a homogeneous slurry is obtained. The slurry is deposited onto a facing material such as a scrim.

Cement-based panels are formed into a panel in a variety of ways. Some embodiments cast the panel in a mold and allow it to set in the mold until it is sufficiently firm to handle. In other embodiments, the slurry is deposited in a prepared form so that the panel cures in situ. In this case, the panel is shaped by a form. After the cement is cured, the form is removed and the building panel is allowed to remain in place. Any method of forming the panel is useful.

In some embodiments of the invention, additives are included in the slurry to modify one or more properties of the final product. Concentrations are reported in amounts per 1000 square feet of finished board panels (“MSF”). A number of additives are commonly used in gypsum slurries. Starches or defoamers are used in amounts from about 6 to about 20 lbs./MSF (29 to about 97 g/m²) to increase the density and strengthen the product. Set retarders (up to about 2 lb./MSF) (up to about 9.7 g/m²)or accelerators (Up to about 35 lb./MSF) (up to about 170 g/m²) are added to modify the rate at which the hydration reactions take place. “CSA” is a set accelerator comprising 95% calcium sulfate dihydrate co-ground with 5% sugar and heated to 250° F. (121° C.) to caramelize the sugar. CSA is available from USG Corporation, Southard, OK Plant, and is made according to U.S. Pat. No. 3,573,947, herein incorporated by reference. Glass fibers are optionally added to the slurry in amounts of at least 9 lb./MSF(at least 43 g/m²). Up to 15 lb./MSF (up to about 73 g/m²) of paper fibers are also added to the slurry. Dispersants or surfactants are common additives to modify the viscosity or surface properties of the slurry. Naphthalene sulfonates are preferred dispersants, such DILOFLOW® from Geo Specialty Chemicals, Cleveland, Ohio. Preferably, a dispersant is added to the core slurry in amounts up to 16 lb./MSF (up to 78 g/m²). Wax emulsions, discussed in more detail below, are added to the gypsum slurry in amounts up to 20 gal./MSF (0.8 l/m²) to improve the water-resistency of the finished gypsum board panel. Pyrithione salts are useful in addition to other preservatives. There are no known adverse effects when pyrithione salts are used together with any other additives. It is therefore contemplated that pyrithione salts are useful when combined with any additives added to the gypsum core slurry to modify other properties of the set gypsum core.

It is necessary to use care when PEG is added in combination with foam and surfactants. Some surfactants form a stable microfoam in the presence of PEG. This microfoam is not easily dispersible, and once formed, the benefits of the PEG are no longer available. Surfactants known to form microfoams of this type include dodecylbenzoate surfactants.

In embodiments of the invention that employ a foaming agent to yield voids in the set gypsum-containing product to provide lighter weight, any of the conventional foaming agents known to be useful in preparing foamed set gypsum products can be employed. Many such foaming agents are well known and readily available commercially, e.g. from GEO Specialty Chemicals, Ambler, Pa. Foams and a preferred method for preparing foamed gypsum products are disclosed in U.S. Pat. No. 5,683,635, herein incorporated by reference.

Fillers are also contemplated for use in some embodiments of the invention. Lightweight aggregate, such as expanded perlite, is optionally added to the stucco to reduce the density of the product building panel. Aggregate, such as pebbles or sand, is also added to cement-containing embodiments. Glass beads, plastic beads or fibers and organic or inorganic fibers are examples of additional fibers that are usable. The amount of fillers is selected depending on the type and amount of dry hydraulic material that has been chosen. Amounts of fillers can range from about 20% to about 200% based on the dry weight of the hydraulic component.

A trimetaphosphate compound is added to the gypsum slurry in some embodiments to enhance the strength of the product and to improve sag resistance of the set gypsum. Preferably the concentration of the trimetaphosphate compound is from about 0.1% to about 2.0% based on the weight of the calcined gypsum. Gypsum compositions including trimetaphosphate compounds are disclosed in U.S. Pat. No. 6,342,284, herein incorporated by reference. Exemplary trimetaphosphate salts include sodium, potassium or lithium salts of trimetaphosphate, such as those available from Astaris, LLC., St. Louis, Mo. A trimetaphosphate compound is added to the gypsum slurry in some embodiments to enhance the strength of the product and to reduce sag resistance of the set gypsum. Preferably the concentration of the trimetaphosphate compound is from about 0.1% to about 2.0% based on the weight of the calcined gypsum. Gypsum compositions including trimetaphosphate compounds are disclosed in U.S. Pat. No. 6,342,284, herein incorporated by reference. Exemplary trimetaphosphate salts include sodium, potassium or lithium salts of trimetaphosphate, such as those available from Astaris, LLC., St. Louis, Mo.

In addition, the gypsum composition optionally can include a starch, such as a pregelatinized starch or an acid-modified starch. The inclusion of the pregelatinized starch increases the strength of the set and dried gypsum cast and minimizes or avoids the risk of paper delamination under conditions of increased moisture (e.g., with regard to elevated ratios of water to calcined gypsum). One of ordinary skill in the art will appreciate methods of pregelatinizing raw starch, such as, for example, cooking raw starch in water at temperatures of at least about 185° F. (85° C.) or other methods. Suitable examples of pregelatinized starch include, but are not limited to, PCF 1000 starch, commercially available from Lauhoff Grain Company and AMERIKOR 818 and HQM PREGEL starches, both commercially available from Archer Daniels Midland Company. If included, the pregelatinized starch is present in any suitable amount. For example, if included, the pregelatinized starch can be added to the mixture used to form the set gypsum composition such that it is present in an amount of from about 0.5% to about 10% percent by weight of the set gypsum composition.

Some gypsum embodiments of the invention include biocides to reduce mold growth. Any known biocide, including boric acid and salts of pyrithione, are added to suppress mold growth under conditions where moisture is present. Preferably the biocide is added to the slurry in amounts of about 100 parts biocide per one million parts stucco, both on a weight basis. One embodiment uses sodium pyrithione as the biocide in a gypsum panel.

When the core is made of a cement based composition, a number of further additives are optionally added depending on the specific application of the building panel. These additives can include set accelerators, set retarders, thickeners, coloring agents, preservatives and other additives in amounts known in the art. Additives for a particular purpose, as well as the appropriate concentrations, are known to those skilled in the art. Coloring agents, such as pigments, dyes or stains are also useful as additives, particularly in flooring applications. Any known coloring agents can be used with this invention. Titanium dioxide is particularly useful to whiten the composition. The coloring agents are used in amounts and added by methods conventionally used for compositions of this type.

While particular embodiments of the gypsum or cement panel with a dedusting agent has been shown and described, it will be appreciated by those skilled in the art that changes and modifications may be made thereto without departing from the invention in its broader aspects and as set forth in the following claims.

What is claimed is:

1. A method of making a dust-reducing building panel comprising:
selecting a dedusting agent that is a solid at room temperature but that melts to form composite particles by at least one of agglomerating and surface adsorption of fines under conditions selected from the group consisting of machining, cutting, abrading or sanding;
making a slurry including water, a dedusting agent and a hydraulic material selected from the group consisting of calcium sulfate hemihydrate and cement;
depositing the slurry onto a facing material;
forming the slurry into a panel; and
allowing the slurry to set.

2. The method of claim 1 wherein said facing material is one of the group consisting of paper, glass fibers and scrim.

3. The method of claim 1 further comprising pacing a second facing material on said slurry to form a sandwich.

4. The method of claim 1 wherein said forming step comprises casting or screeding.

5. The method of claim 1 further comprising forming the dedusting agent in situ.

6. The method of claim 5 wherein said producing step comprises adding an alkoxy-substituted alkylene oxide to the water.

7. The method of claim 1 wherein said selecting step comprises selecting from the group consisting of dedusting agent and natural wax.

8. The method of claim 7 wherein said dedusting agent is a propylene glycol.

9. The method of claim 1 wherein said selecting step comprises selecting a dedusting agent having a melting point of from about 80° F. to about 150° F.

10. The method of claim 9 wherein said selecting step comprises selecting a dedusting agent having a melting point of from about 90° F. to about 120° F.

11. The method of claim 1 wherein said selecting step comprises selecting a dedusting agent having a molecular weight of about 1,000 to about 20,000 Daltons.

12. The method of claim 1 further comprising adding foam to the slurry prior to the depositing step.

13. The method of claim 1 further comprising introducing additives selected from the group consisting of a strength enhancing agent, a set time modifier, a binder, a filler, and mixtures thereof into the slurry.

14. The method of claim 1 wherein said forming step forms the slurry into a gypsum panel.

15. The method of claim 1 wherein said forming step forms the slurry into a cement board.
